(19) United States
(12) Patent Application Publication
(10) Pub. No.: US 2017/0104927 A1
(43) Pub. Date: Apr. 13, 2017

(54) SYSTEMS, METHODS AND SOFTWARE PROGRAMS FOR 360 DEGREE VIDEO DISTRIBUTION PLATFORMS

(71) Applicant: Little Star Media, Inc., New York, NY (US)

(72) Inventors: John Anthony Mugavero, New York, NY (US); Wells Johnston, New York, NY (US); Joseph Werle, New York, NY (US); Dominic Giglio, New York, NY (US)

(21) Appl. No.: 15/288,928

(22) Filed: Oct. 7, 2016

Related U.S. Application Data
(60) Provisional application No. 62/238,325, filed on Oct. 7, 2015.

(51) Int. Cl. H04N 5/232; G06F 3/01; G06T 7/60; H04N 13/04

(52) U.S. Cl. CPC H04N 5/23238; H04N 13/0429; G06F 3/012; G06T 7/60

(57) ABSTRACT

Featured are systems, methods, and programs for the delivery and analysis of viewing experiencing for 360° video. The systems related to the invention described are intended for the optimization, transcoding, delivery, playback, and analysis of 360° video. Methods employed by such systems include mathematical analysis, geometry, networking, user interaction, graphical I/O, and various hardware devices. Software programs related to the invention include the playback and analysis of 360° video. Such analysis includes the recording of mathematical structures that exist in Euclidean space over time that is stored in a remote location and transferred over a public or private network.

### FIELD OF INVENTION

The present invention relates to systems, methods and software applications programs for 360° video distribution platforms that are capable of rendering 360° video such as web browser, a mobile device, a head-mounted display, or a virtual reality headset. Such systems include one or more computers, digital processing device, integrated circuits or the like and such methods preferably are carried out or performed on such one or more computers, digital processing device, integrated circuits or the like. Such systems, methods and software programs also are such as to include automated and/or suggestive viewing for 360° video.

### BACKGROUND OF THE INVENTION

A 360 video distribution platform delivers 360° video over public and private networks to client applications running on platforms that support the rendering of 360° video. The video is transcoded and optimized for the platform recipient. The video also is typically delivered to the client or end user compressed in an equirectangular or cube map projection. There is shown in FIG. 1A and FIG. 1B, respectively illustrative equirectangular and cube map projections.

Such a 360° video is delivered to a capable platform of the end user and is prepared for playback. The 360° video playback occurs by mapping an equirectangular or cube map format video to a geometry such as that shown in FIG. 3A prior to uv mapping. The container (i.e., the format in which the data is held) the video is dependent on the platform capable of decoding a video stream.

When delivered to the end user, the orientation and field of view determine what the perspective will be. There is shown in FIG. 2A a screenshot of an video format that is unbounded and FIG. 2B shows a screenshot that exemplifies such a rendering.

It thus would be desirable to provide improved/new 360 degree video systems that are able to render content on web, mobile, head-mounted displays and/or a virtual reality headset(s) as well as software applications and methods related thereto.

### SUMMARY OF THE INVENTION

The present invention features 360 degree video systems that are able to render content on web, mobile and head-mounted displays and/or a virtual reality headset(s) as well as software applications and methods related thereto. Such methods and software programs include keeping track of the viewer's position as the viewer(s) watches the video and is looking around at the spherical content. More particularly, this is accomplished by keeping track of two angles—radians—relative to the origin of the sphere. More specifically, the methods and software program includes recording the viewer's position periodically such as recording once every second and at the end of a video, such methods and software program includes logging or saving the tracking data.

In further aspects/embodiments of the present invention such methods further comprise determining a viewing route through the video taken by a prior viewer(s) using the tracking data; and using the determined viewing route by a subsequent viewer so that the subsequent viewer can watch the video according to the determined viewing route.

In yet further aspects/embodiments, for such a method there is tracking data for a plurality of prior viewers; and the viewing route is determined using the tracking data for the plurality of prior viewers.

In yet a further aspect of the present invention there is featured a method for generating a 3D heat map that shows an aggregate visualization of where everyone viewing the video has looked. Such a method includes tracking the position of the viewer as the viewer watches the video and is looking around at the spherical content. Where said tracking further includes keeping track of two angles—radians—relative to the origin of the sphere. Such a method also includes recording the viewer's position periodically and at the end of a video, logging the tracking data. Such methods further includes parsing the logged tracking data, and transforming the two radian values for each recorded view and generating a 2d array representative of the two radian values.

According to further aspects/embodiments of the present invention there is featured a system for rendering a 360 degree video including a computing device and a software program for execution on the computing device. Such a software program includes instructions, criteria and code segments for executing a method including the steps of: tracking the position of the viewer as the viewer watches the video and is looking around at the spherical content and wherein said tracking further includes keeping track of two angles—radians—relative to the origin of the sphere; recording the viewer's position periodically; and at the end of a video, logging the tracking data.

In yet further aspects/embodiment, the method embodied in the software program comprises the step(s) of: determining a viewing route through the video taken by a prior viewer(s) using the tracking data; and using the determined viewing route by a subsequent viewer so that the subsequent viewer can watch the video according to the determined viewing route.

In yet further aspects/embodiment, for such a method there is tracking data for a plurality of prior viewers; and the viewing route is determined using the tracking data for the plurality of prior viewers

Other aspects and embodiments of the invention are discussed below.

### DEFINITIONS

The instant invention is most clearly understood with reference to the following definitions:

USP shall be understood to mean U.S. Patent Number and U.S. Publication No. shall be understood to mean U.S. Published Patent Application Number.

The terms “comprising” and “including: as used in the discussion directed to the present invention and the claims are used in an open-ended fashion and thus should be interpreted to mean “including, but not limited to.” Also the terms “couple” or “couples” is intended to mean either an indirect or direct connection. Thus if a first component is coupled to a second component, that connection may be through a direct connection, or through an indirect connection via other components, devices and connections. Further the terms “axial” and “axially” generally mean along or substantially parallel to a central or longitudinal axis, while the terms “radial” and “radially” generally mean perpendicular to a central, longitudinal axis.

Reference to a singular item, includes the possibility that there are plural of the same items present. More specifically, as used herein and in the appended claims, the singular forms “a,” “and,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

Directional terms such as “above,” “below,” “upper,” “lower,” etc. are used for convenience in referring to the accompanying drawing figures. In general, “above,' “upper,” “upward” and similar terms refer to a direction toward a proximal end of an instrument, device, apparatus or system and “below,” “lower,” “downward,” and similar terms refer to a direction toward a distal end of an instrument, device, apparatus or system, but is meant for illustrative purposes only and the terms are not meant to limit the disclosure.

FOV shall be understood to represent or mean field-of-view.

A computer readable medium shall be understood to mean any article of manufacture that contains data that can be read by a computer or a carrier wave signal carrying data that can be read by a computer. Such non-transitory computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; or paper media, such as punched cards and paper tape. Such transitory computer readable media includes a carrier wave signal received through a network, wireless network or modem, including radio-frequency signals and infrared signals.

Platform shall be understood to mean a system or device capable of rendering 360° video such as a web browser, a mobile device, a head-mounted display, or a virtual reality headset.

End user shall be understood to mean the user viewing the 360° video on a platform capable of rendering a 360° video.

R³, or Euclidean space shall be understood to represent a 3D space of real numbers such that R³={(a1, a2, a3): a1, a2, a3 R}.

R², or a Cartesian coordigate system shall be understood to represent a 2D plane of real numbers such that R²={(a1, a2): a1, a2 R}.

FOV, or fov, shall be understood to represent or mean field-of-view.

HMD, or hmd, shall be understood to represent or mean head-mounted display or refer to a virtual reality headset.

Camera shall be understood to mean the viewer.

Viewer shall be understood to mean the end user “viewing” the media.

Origin, or zero-vector shall be understood to mean the origin point in Euclidean space of the camera, or viewer.

Center shall be understood to mean center point of a geometric structure or graph.

Graph shall be understood to mean a plane existing in R³ or R².

Network shall be understood to mean a set of interconnected devices that may or may not be publicly accessible.

Stream, or streaming shall be understood to mean the act of data transference over a public or private network.

Recipient shall be understood to mean the end user or device.

Transcode shall be understood to mean the transformation of an input 360° video to an optimized 360° video.

Tuple shall be understood to mean an ordered list of n elements.

Equirectangular shall be understood to mean a projection that maps meridians to vertical straight lines of constant spacing, and circles of latitude to horizontal straight lines of constant spacing.

Cube map, or cube mapping shall be understood to mean a projection that maps an image to size faces of a cube. This is also known as environment mapping.

Distribution shall be understood to mean the delivery over a public or private network of 360° video, assets, metadata, and external mediums associated with the 360° video for an end user experience including the use of systems, methods, and external or internal software programs related to the rendering and playback of a 360° video on platforms capable of rendering and playback of 360° video.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1A is a pictorial view of a conventional Equirectangular projection of earth.

FIG. 1B is a pictorial view of a conventional Cube map projection of a scene in a park.

FIG. 2A is a pictorial view of a conventional screenshot of a video format unbounded.

FIG. 2B is a pictorial view of an illustrative screenshot of the orientation and field of view of the perspective being rendered to the end user as shown in FIG. 2A.

FIGS. 2C, D are illustrative views of a viewing frustum with the field of view projected onto an equirectangular image (FIG. 2C) and a viewing frustum with the field of view projected onto an equirectangular image (FIG. 2D)

FIG. 3A is an illustrative view of spherical coordinates that illustrates the two angles that keep track of when using the systems and methods of the present invention and when someone is watching a spherical video. The radians are the horizontal and vertical angles from the origin of the sphere.

FIG. 3B is an illustrative view of a spherical geometry illustrating vector normal directed from the center.

FIG. 3C is another illustrative view showing Euler angles representing rotation about z, N and Z axes.

FIG. 3D is a pictorial view visually demonstrating mapping of a point in a Euclidean plane to a Cartesian plane.

FIGS. 4A-B are graphical views visualizing a single element of the set Vₙ (FIG. 4A), where the black squares represent a weight of 1 as this is a single element being viewed and A visualization of two elements of the set Vⁱₙ, (FIG. 4B), where the black squares represent a weight of 2, and the grey represents a weight of 1 as two elements are being viewed.

FIGS. 5A-D are various views of exemplary three dimensional heatmaps, FIG. 5A is a heatmap visualization of element of set Vⁱₙ where i=0; FIG. 5B is a heatmap visualization of element of set Vⁱₙ where i=1; FIG. 5C is a heatmap visualization of element of set Vⁱₙ where i=2 and FIG. 5D is a heatmap visualization of element of set Vⁱₙ where i=3.

FIGS. 6A, B are pictorial views illustrating mapping a portion of a 3D sphere to a 2D image when looking straight ahead as seen in a 360 video (FIG. 6A) and in an actual stereoscopic FOV (FIG. 6B).

FIGS. 6C, D are pictorial views illustrating mapping a portion of a 3D sphere to a 2D image when looking up and right from the origin as seen in a 360 video (FIG. 6C) and in an actual stereoscopic FOV (FIG. 6D).

FIGS. 7A-D are various views of a three dimensional heatmap (FIGS. 7A, 7C) and a 2-d array developed from parsing of the tracking data.

FIGS. 8A-F are various pictorial views of examples of a heatmap generated from ten views over the first six seconds of a video, where: the heatmap for the first second is shown in FIG. 8A, the heat map for the 2^{nd} second is shown in FIG. 8B, the heat map for the third second is shown in FIG. 8C, the heat map for the fourth second is shown in FIG. 8D, the heat map for the fifth second is shown in FIG. 8E, and the heat map for the sixth second is shown in FIG. 8F.

FIGS. 9A-D are various views illustrating results of cluster analysis where an example of all the raw orientation data plotted for one second in one video is shown in FIGS. 9A, 9C and the results of cluster analysis of the respective raw data is shown in FIGS. 9B, 9D.

FIG. 10 is another pictorial view illustrating optimizing of the video encoding based on where people are looking thereby optimizing the encoding so that the highest bitrate is optimized for the hotspots in the viewing experience (in other words optimizing the highest video image quality in the area that people are viewing the most).

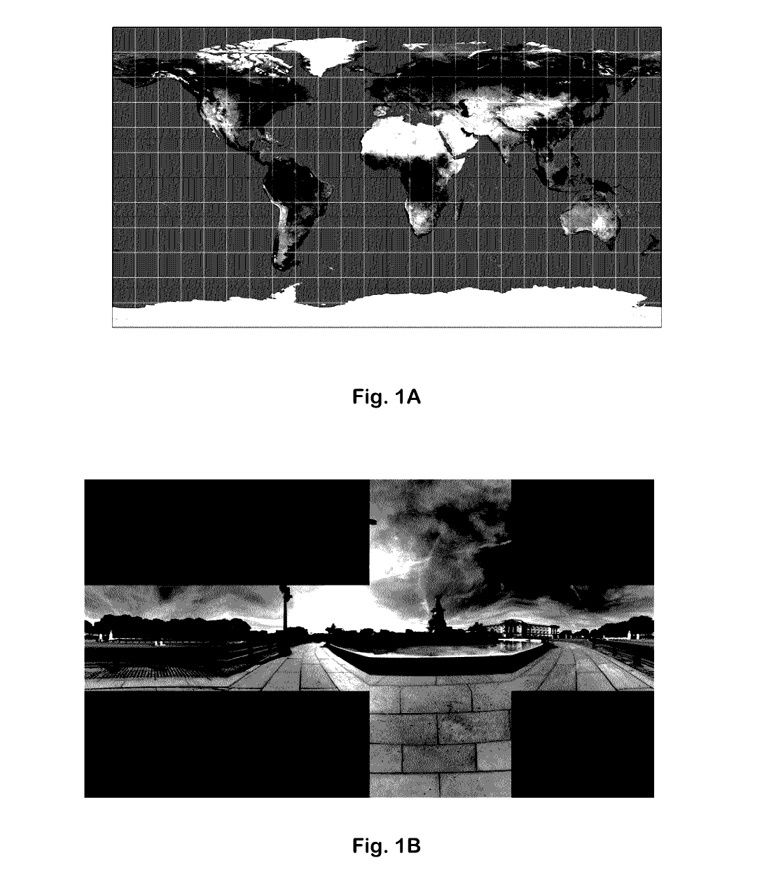

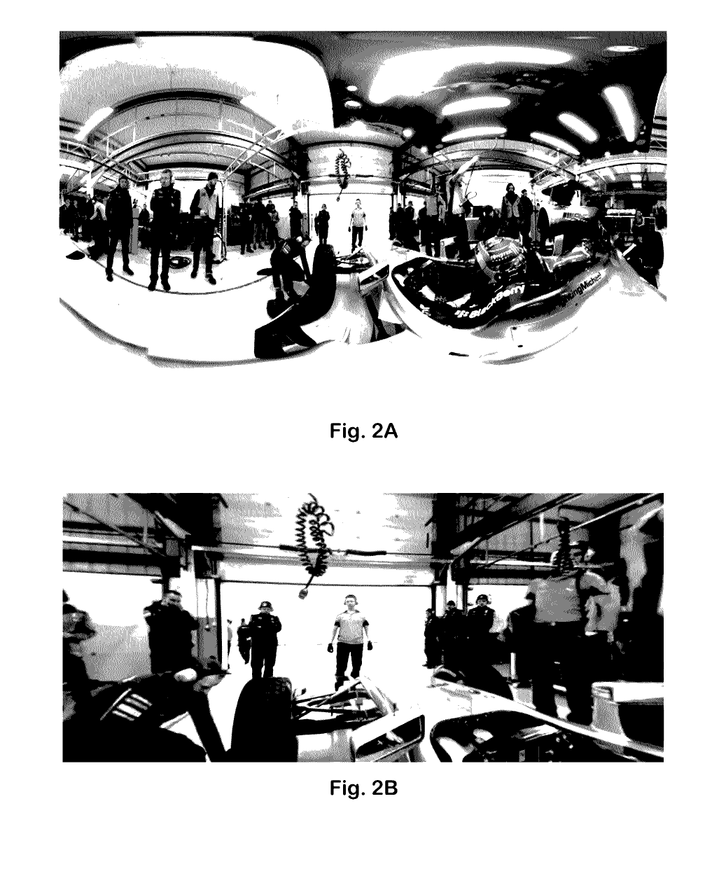

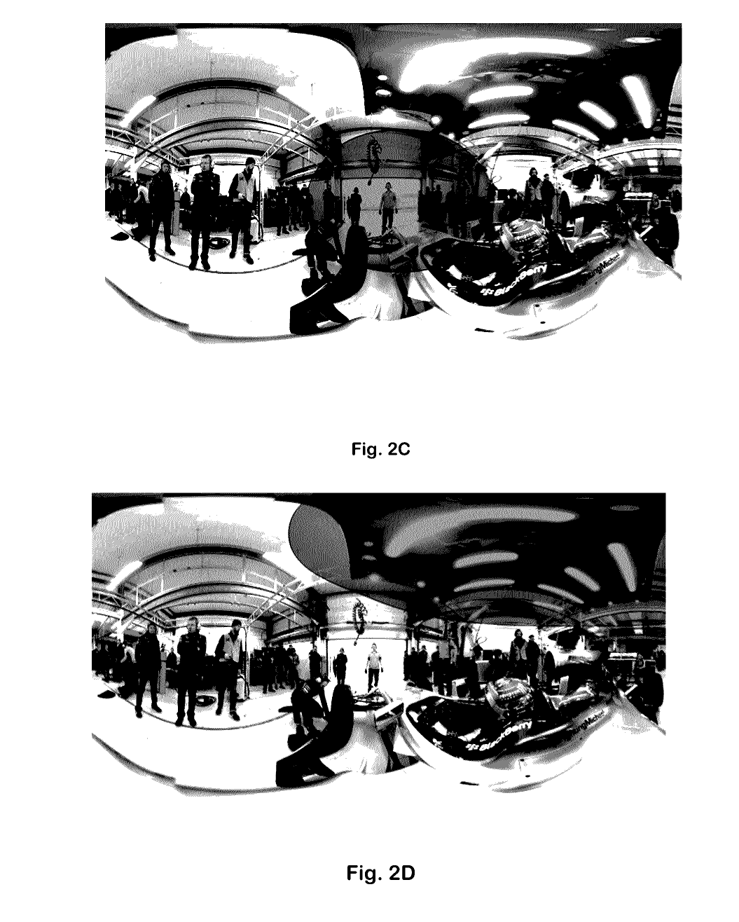

### DESCRIPTION OF THE PREFERRED EMBODIMENT

Before the present invention is described in detail, it is to be understood that this invention is not limited to particular variations set forth and may, of course, vary. Various changes may be made to the invention described and equivalents may be substituted without departing from the true spirit and scope of the invention. In addition, modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The software applications of the present invention can be implemented on a computer, a server or the like which software applications embody instructions, criteria, data and/or code segments that embody logic, method steps and the like which implement the instructions, criteria, code segments and/or methodology that are embodied in such an application(s). Such computer systems also can include communication subsystems or devices that allow computers and/or servers comprising the system to communicate with each other as well transmitting information/data via a local area network (LAN), wide area network (WAN), other networks known in the art or hereinafter developed and/or via the Internet.

As is known to those skilled in the art such a computer and/or server is configured and arranged so as to include a computer processor such as a microprocessor or the like (e.g., application specific integrated chip—ASIC), and a memory that are connected by a bus or other communications backplane. The memory is a relatively high speed machine readable medium and includes Volatile Memories such as RAM, DRAM, and SRAM, and Non-Volatile Memories such as, ROM, FLASH, EPROM, EEPROM, and bubble memory. Also connected to the bus are a secondary storage, external storage, output devices such as a monitor or display device or printers and/or input devices such as a keyboard and a mouse. The secondary storage includes machine-readable media such as hard disk drives, magnetic drum, bubble memory and/or solid state drives. The external storage includes machine-readable media such as FLASH drives, floppy disks, removable hard drives, magnetic tape, CD-ROM, and even other computers, possibly connected via a communications line (e.g., LAN, WAN, Internet). The distinction drawn here between secondary storage and external storage is primarily for convenience in describing the invention. As such, it should be appreciated that there is substantial functional overlap between these elements.

Computer software includes operating systems and user programs such as that to perform the actions or methodology of the present invention as well as user data that can be stored in a computer software storage medium, such as the memory, secondary storage, and external storage for execution on the computer/server. Executable versions of computer software, such as browser, operating system, and other operating software can be read from a non-volatile storage medium such as the external storage, secondary storage, and non-volatile memory and loaded for execution directly into the volatile memory, executed directly out of the non-volatile memory, or stored on the secondary storage prior to loading into the volatile memory for execution on the computer processor.

The flow charts and/or description herein illustrate the structure of the logic(s) of the present invention as embodied in a computer program software for execution on a computer, digital processor or microprocessor. Those skilled in the art will appreciate that the flow charts and the description herein illustrate the structures of the computer program code elements, including logic circuits on an integrated circuit that function according to the present invention.

As such, the present invention is practiced in its essential embodiment(s) by a machine component that renders the program code elements in a form that instructs a digital processing apparatus (e.g., computer) to perform a sequence of function step(s) corresponding to those shown in the flow diagrams and/or as described herein.

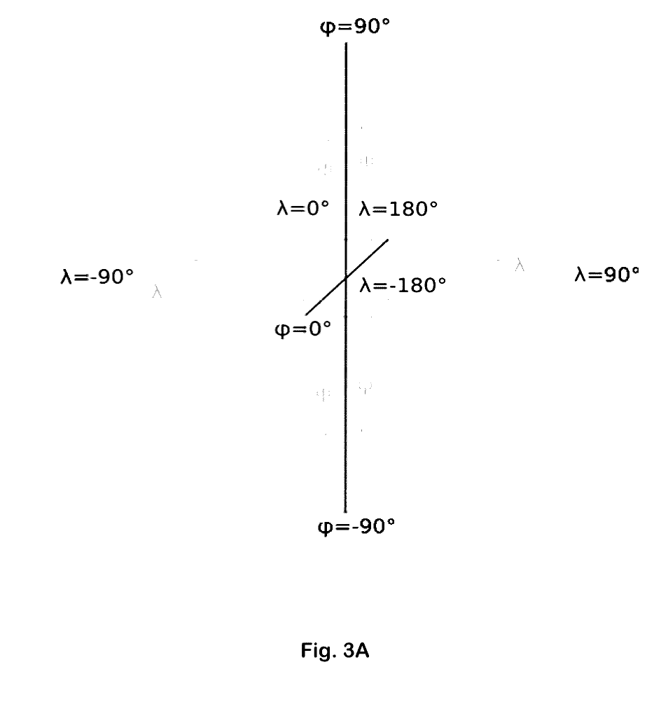

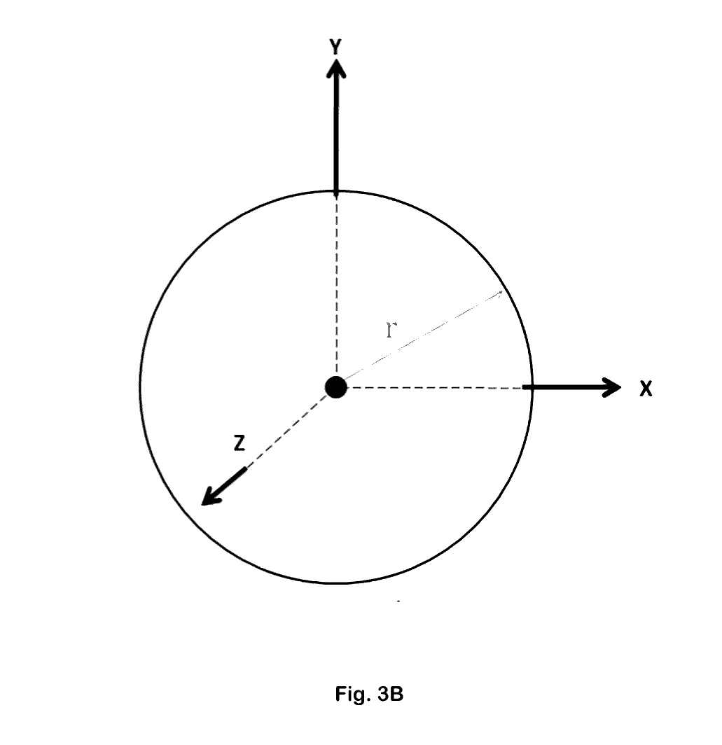

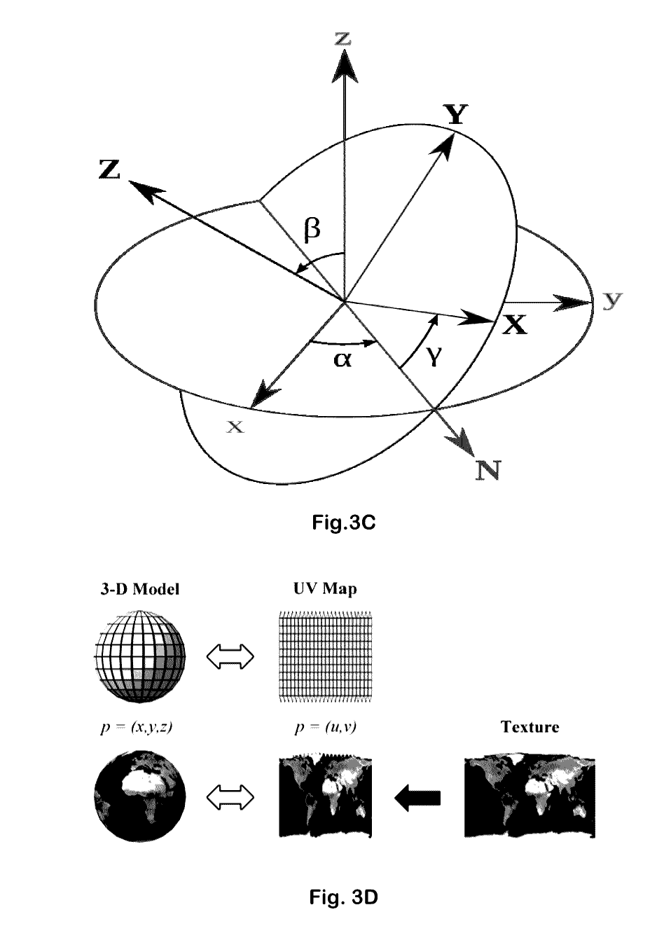

According to an aspect of the present invention, there is shown in FIG. 3A an illustrative view of spherical coordinates or geometry that illustrates the two angles (Φ and λ) that are used for tracking when using the systems and methods of the present invention and when someone is watching a spherical video. The radians are the horizontal and vertical angles from the origin of the sphere. There also is shown in FIG. 3B a spherical geometry illustrating vector normals directed away from the center.

As described further herein, according to an aspect of the present invention such systems, methods and software programs are configured to allow the end user to use automated and/or suggestive viewing for the 360° video. In automated and/or suggestive viewing the end user views the video based on how prior viewers viewed the same video. In other words, data and/or information is collected based on the pathway or route the prior viewer(s) followed as they navigated the 360° video. This data or information is then used to develop a route or pathway for viewing the particular video.

Thus, when the end user implements automated and/or suggestive viewing, the systems and methods or the like of the present invention are configured and arranged so as to automatically control the viewing perspective of the video for the given end user. In other words the perspective or FOV of the viewer is automatically altered or adjusted based on the prior viewings. In such a case, the end user need not take the actions necessary to change the perspective or FOV.

In more particular embodiments, such systems and methods are further configurable such that if the end user implements actions to manually or directly control the perspective or FOV, then such systems and methods are configurable so as to thereafter discontinue the automated and/or suggestive viewing of the video. It should be noted that such a viewing process does not require that the video being distributed to the end user be pre-processed before delivery.

As shown in FIG. 3B, the center of the geometry represents the viewing origin, or the camera. The camera's field of view represents a frustum, or view that is visible to the end user. A user experiences a 360° video by rotating the camera about the center as well as in effect rotating the perspective or FOV while viewing the video. According to an embodiment of the present invention, the camera, or view, is changed based on user input such as by using a mouse, keyboard, mobile device, controller, head-mounted display, or virtual reality headset. In this way, the end user adjust the view manually or directly. Camera, or view orientation changes provide meaningful insight into how a user experiences a 360° video.

According to another aspect/embodiment, the rotations or data/information relating to such rotations/movement is recorded over time to provide insight for content creators.

More particularly, and as described herein, in more preferred aspects such data or information is recorded periodically. In more particularly embodiments, the position is recorded once every second. Such data or information also allow for suggesting orientation changes to an end user who should be looking somewhere else.

As also further described herein, such data and/or information is be used in connection with automated or suggestive viewing so as to automatically control viewing of the 360° video for the end user. In this aspect/embodiment, the recorded data is successively processed so as to create a viewing route or pathway while watching the video. The systems, software and methods of the present invention, are configured and arranged so that the end user can select the determined route or pathway and thereafter the systems and methods control viewing such that the perspective or FOV is automatically changed so that the viewing by the end user follows the created route or pathway. Thus, FOV and/or respective rotates about the different axes with respect to the viewing origin based on the created pathway/route.

As shown in FIG. 3B, the center of the geometry represents the viewing origin, or the camera. The camera's field of view represents a frustum, or view that is visible to the end user. A user experiences a 360° video by rotating the camera about the center. The camera, or view, is changed based on user input such as a mouse, keyboard, mobile device, controller, head-mounted display, or virtual reality headset (see e.g., FIG. 3C, which shows Euler angles representing rotations about a, N and Z axes). Camera, or view orientation changes provide meaningful insight into how a user experiences a 360° video. Rotations can be recorded over time to provide insight for content creators. They also allow for suggesting orientation changes to an end user who should be looking somewhere else.

The end user experiences a 360° video over time, much like a traditional video. Traditional methods of video control like play, pause, seek, and volume are provided. In the present invention, the traditional video viewing experience is augmented by the immersive attribute of a 360° perspective of the media. The viewer experiences the 360° video by navigating with user input like a controller, HMD, or mobile device to change the viewer's orientation. Orientation changes happen at variable rate modifying several matrices that affect the output rendered to the viewport.

Automated and learned orientation changes become possible which provide a way for a less demanding and lean back experience. This type of experience provides immersion without the requirement for putting control entirely in the hands of the end user. This type of experience gives end users an alternate perspective of a 360° video.

### Screen Space Translation

When delivered to an end user, a 360° video can be rendered by mapping texels to a geometry in R³, or Euclidean space. The geometry is determined ahead of time and is dependent on the projection format.

Given an equirectangular format for a 360° video, the texels can be mapped to a sphere geometry with 2D Cartesian points in the form:

u=0.5+arctan 2(dz,dx)/2π

v=0.5−arcsin 2(dy)/π

Where a tuple (u, v) represents a point on a Cartesian plane. This point maps a texel to a 2D image, or framebuffer that is rendered to a viewport. FIG. 3D illustrates the process of mapping a 3D point to a 2D plane.

The viewport, or graphical view of the 360° video is determined by perspective, view, and model matrices. The perspective matrix determines a frustum, or viewing depth. The view matrix transforms homogeneous coordinates in Euclidean space to screen coordinates. A model matrix represents a transform applied to each vertex in a geometry. This matrix allows for translations, scales, and rotations to be applied to a geometry. These matrices determine how a geometry is translated to a screen space and viewable with screen pixels.

Viewing Orientation Tracking

The field of view and orientation of the camera is critical for the viewing experience of 360° video. The camera orientation and FOV determine what image will be presented to the end user. The orientation of the camera expressed as an Euler angle (in radians) over time with a fixed or computed FOV provides a linear story of the end user's viewing experience.

The camera's orientation over time represented as a set of tuples Oₙ=1{(x, y, z, t), . . . oₙ} n>0 where the components xyz represent rotations expressed around their respective axis, and component t represents a unique moment in time relative to set siblings. This presents an opportunity for a new set Vⁱₙ={O₁, O₂, . . . , Oₙ} n>0 containing a collection of unique orientation changes over time. The length of set Vⁱₙ represents viewership for a particular 360° video and its elements represent rotations over time from the viewing origin (zero vector).

Cluster Analysis

A fixed, computed, or known field of view allows for computation of a 2D Cartesian point. The computed 2D Cartesian point represents the center of the plane in viewing frustum (see FIG. 3B) perpendicular to the origin of the viewer. This point represents input data for cluster analysis, specifically where viewers at scale are looking. If the format of the source 360° video is equirectangular, this data can be represented as an orthogonal graph Gₙ. Cartesian points Cₙ derived from rotation changes over time can be projected orthographically onto a plane Pₙ. This plane is isomorphic to the texel plane described in an equirectangular format and is congruent in resolution to the source 360° video. Graph Gₙ represents a clusters of points over time that can be analyzed.

Hotspots

Cluster analysis can yield “hotspot” detection. Hotspots identity points of interest in a graph. To identify a hotspot in a video, a combination of k-means and mean-shift clustering algorithms is used for each Gₙ. A single interval of time t for Gₙ can be viewed (see FIG. 3A).

Viewership Heatmaps

Audience tracking and viewership orientations over time as expressed by the set

Vⁱₙ={O₁, O₂, . . . , Oₙ} n>0

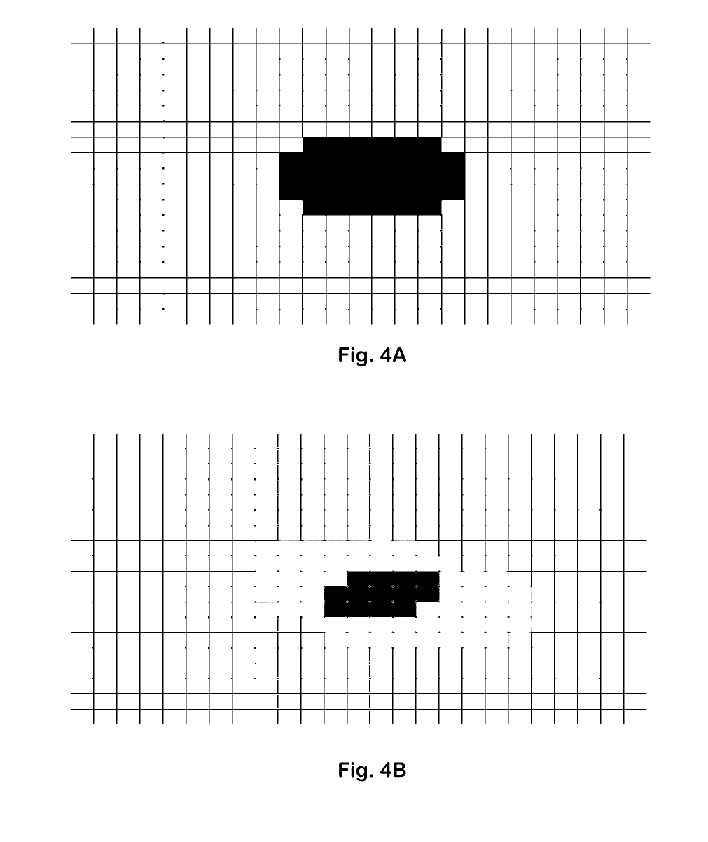

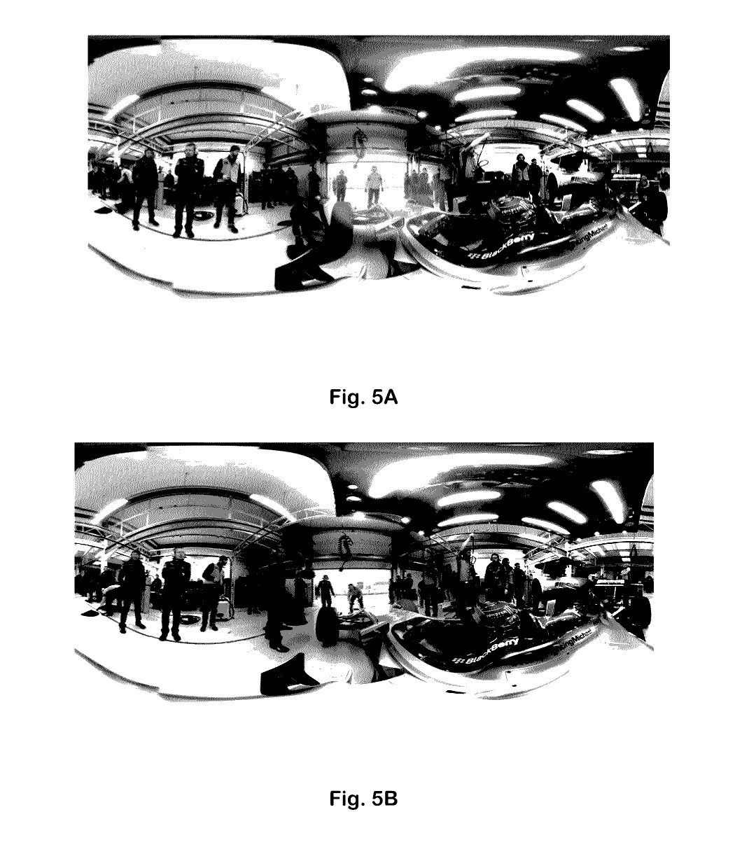

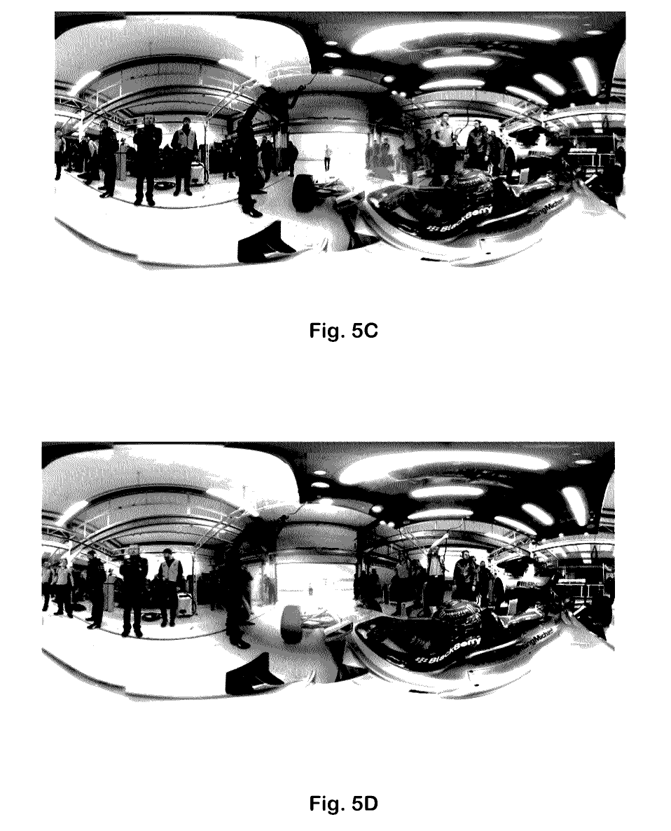

provide an extraordinary amount of insight into how a viewer experiences a 360° video. A single element of the set Vⁱₙ is illustrated in FIG. 4A The black squares represent a weight of 1 as this is a single element being viewed. As the number of elements in the set Vⁱₙ increases so does the aggregate representation plotted on the 2D Cartesian plane as illustrated in FIG. 4B. The clusters can become distinct and form regions of human interpretable data that can be visualized as gradients of color in the form of a heatmap. FIGS. 5A-5D visualize heatmaps at an interval “i” where each element i could be an analysis of orientation at a particular moment in time. A sequential encoding of the images with interpolation could yield a video representing that data over time. This presents an insightful experience as to how the end user can experience a 360° video over time.

Automated Viewing

Cluster analysis of user experience allows for smarter immersive experiences and better decision making for content creators. Heatmap generation at an interval for each captured time t in a 360° video allows for visual insight. The orientation rotations, or data, captured can be provided as input for an artificial neural network to provide learned or suggestive rotations for a specific 360° video. The output of such network would give way to an automated or enhanced viewing of a 360° video. The automated viewing is suggestive and non-obstructive. Changes between viewing angles should be interpolated smoothly. In the event of user interaction, the control is relinquished to the end user. This provides a seamless transition for automated and user driven viewing.

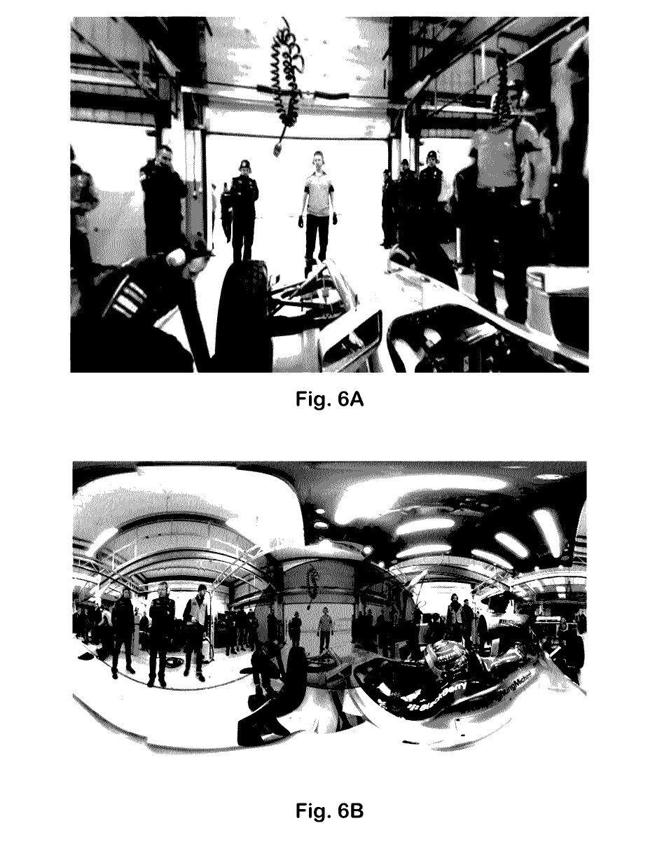

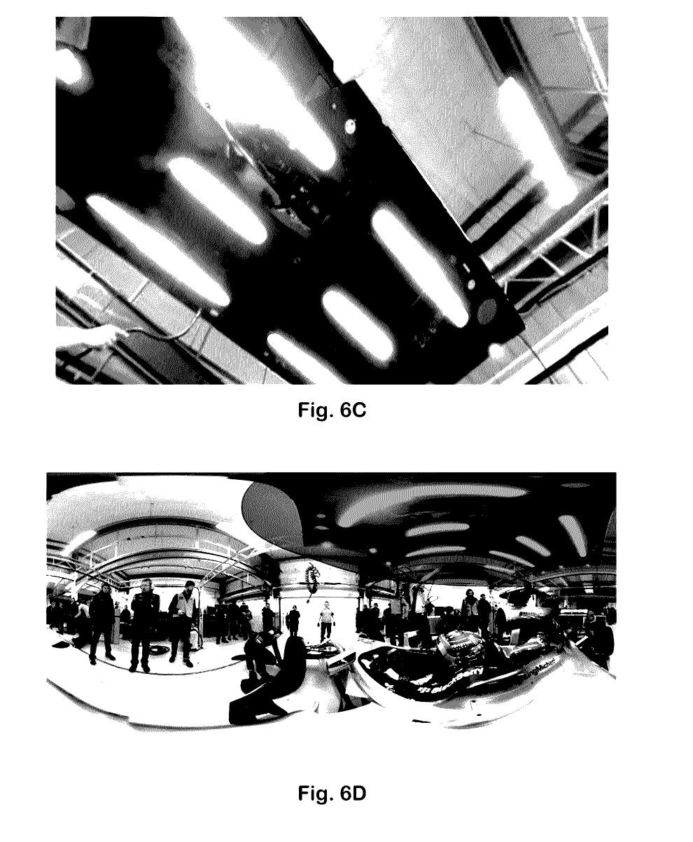

Referring now to the various figures of the drawing wherein like reference characters refer to like parts, there is shown in FIGS. 6A-6D various views illustrating mapping a portion of a 3D sphere to a 2D image as well as positional tracking data. As shown, the user's perspective of the video is from the center of the sphere, so at any given moment they are only looking at a portion of the 360 video. The first challenge from analyzing 360 video viewing data is determining what part of the video is being seen at any given time. As one is mapping a portion of a 3D sphere to a 2D image, normalizing the FOV is non-trivial. See for example FIGS. 6A, B which are pictorial views illustrating mapping a portion of a 3D sphere to a 2D image when looking straight ahead as seen in a 360 video (FIG. 6A) and in an actual stereoscopic FOV (FIG. 6B). See also for example, FIGS. 6C, D which are pictorial views illustrating mapping a portion of a 3D sphere to a 2D image when looking up and right from the origin as seen in a 360 video (FIG. 6C) and in an actual stereoscopic FOV (FIG. 6D). As one can see, the FOV (and what is consider to be “seen”) changes based on the dimensions of the video and the direction the person is looking in.

As a user watches a video and looks around the spherical content, one needs to keep track of their position and account for the FOV in order to do large-scale analysis on viewing data. As viewing data is generated differently in all mediums (mobile vs web vs head-mounted display), a consistent way is needed to represent the camera angle. This is done in the present invention by keeping track of two angles—radians—relative to the origin of the sphere (see FIG. 3A). This image illustrates the two angles (λ and Φ) that are kept track of when someone is watching a spherical video. The radians are the horizontal and vertical angles from the origin of the sphere. The end user's position is known during every frame of the video. If one recorded all of this information in real time, it would be present too much data to deal with. Thus, in more preferred aspects of the present invention and so as to reduce the size or amount of tracking data, the position is recorded periodically. In more particularly embodiments, the position is recorded once every second.

At the end of a video, the tracking data is logged or saved so it can be later used for analysis. Such logs are stored in flat text files such as JSON on FTP servers (Amazon S3). As described further herein there are a number ways one can utilize the data.

In one embodiment, a 3-dimensional heatmap is generated that shows an aggregate visualization of where everyone has looked in a video at every second or the specified periodic interval. To generate this heatmap, the logs are parsed and one keeps track of a 2d array for each periodic interval of the video that will be used as input into our heatmap software.

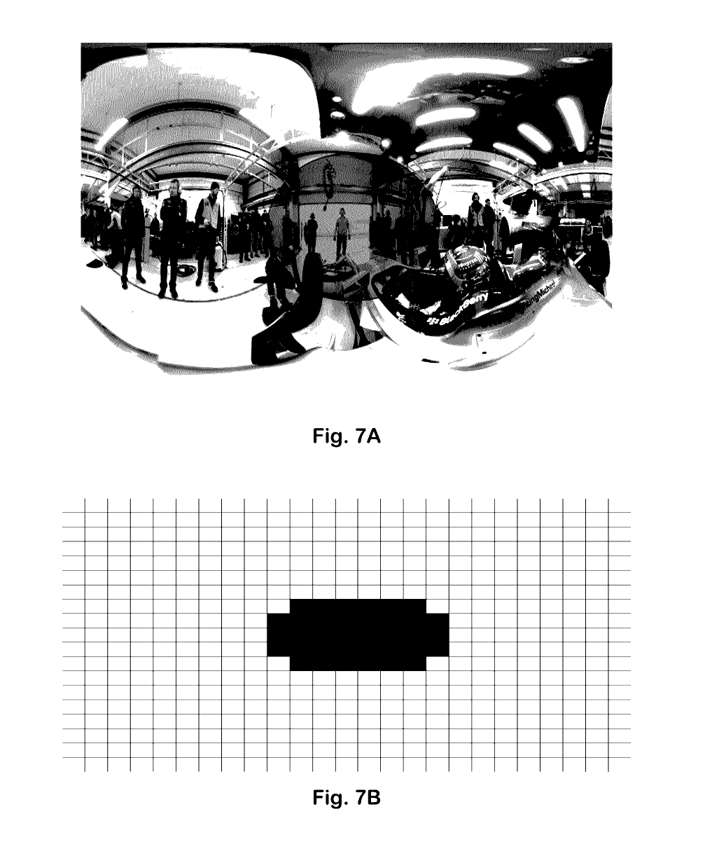

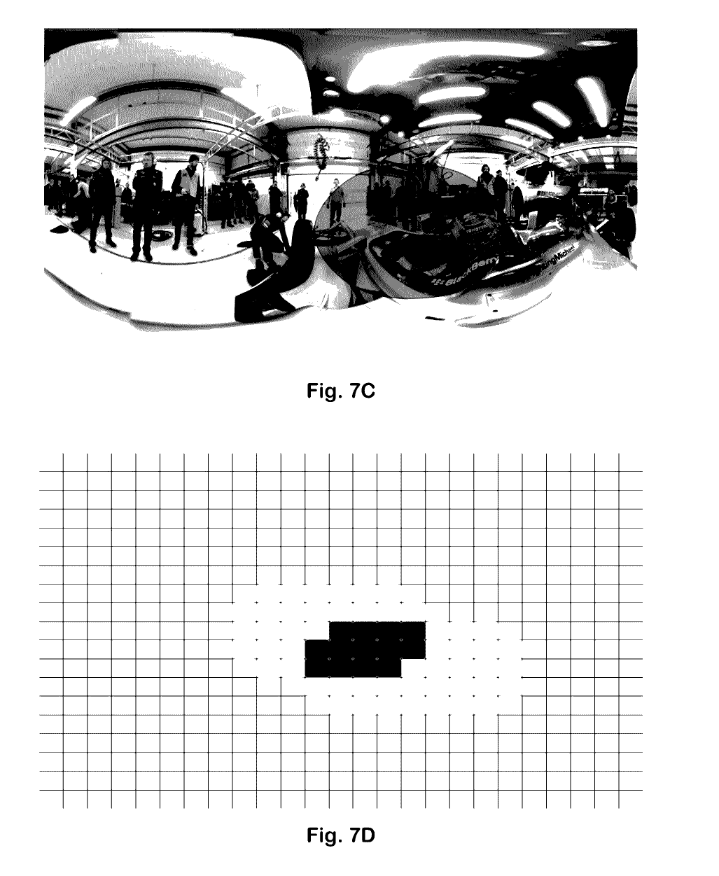

When parsing the logs, the two radian values for each interval or second of each view (per video) are transformed into a 2d array. A visualization of what a view at a particular second would look like as array data is shown in FIGS. 7A, B. As this only represents one view, the black dots in FIG. 7B represent a weight of 1.

When as more logs are parsed, the array representations change to reflect the actual aggregate weight of everyone's views. For example, as shown in FIGS. 7C, D there is shown a second piece of viewing data added to the aggregate representation. Here, the grey represents a weight of 1, and the black represents a weight of 2 (as two people have seen it) in FIG. 7D. The weights are stored as numbers internally.

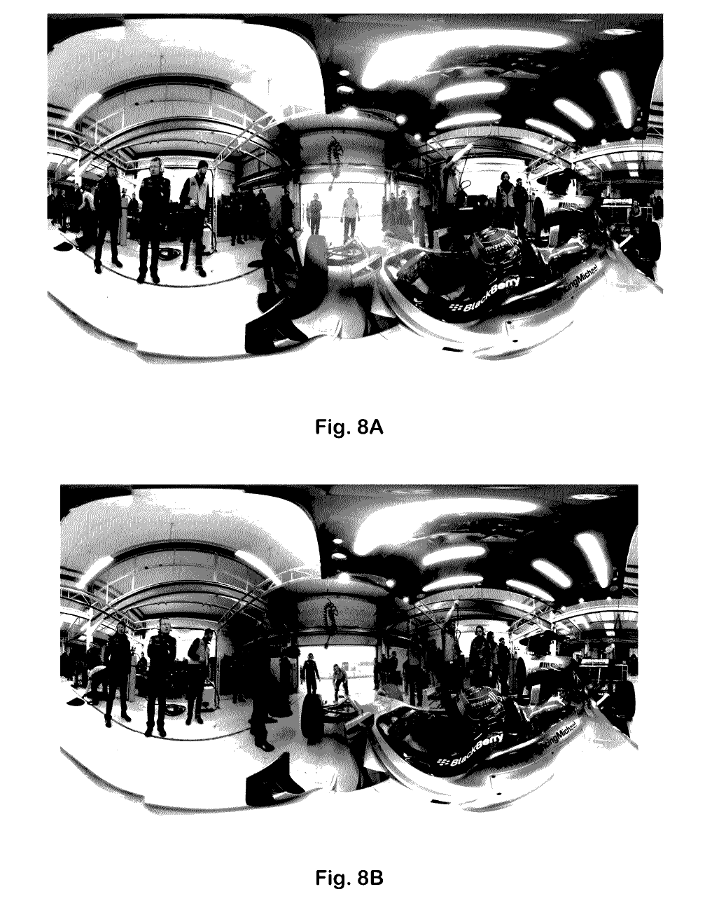

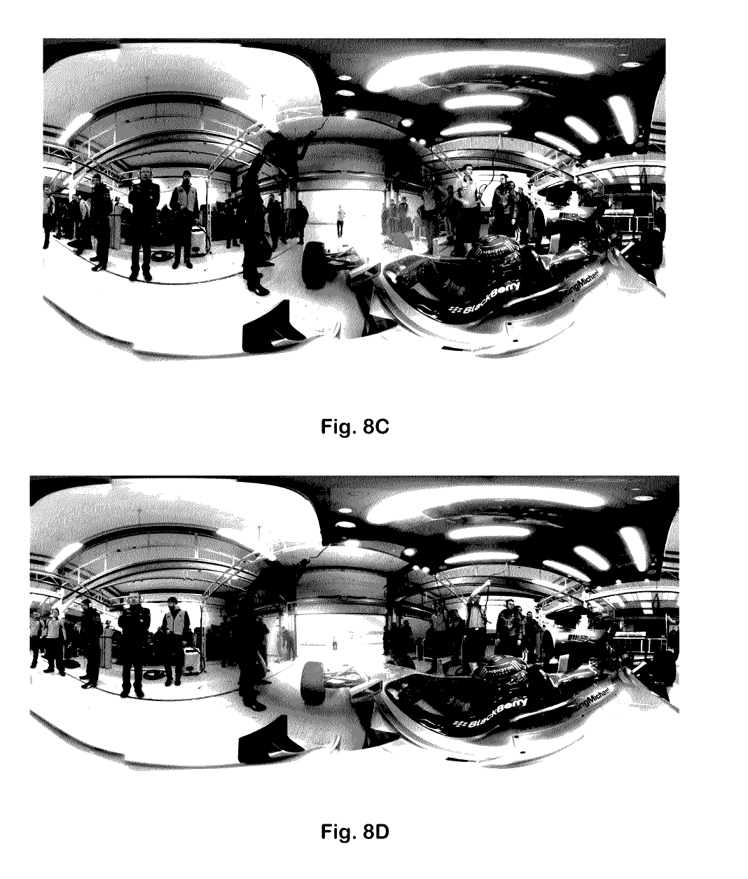

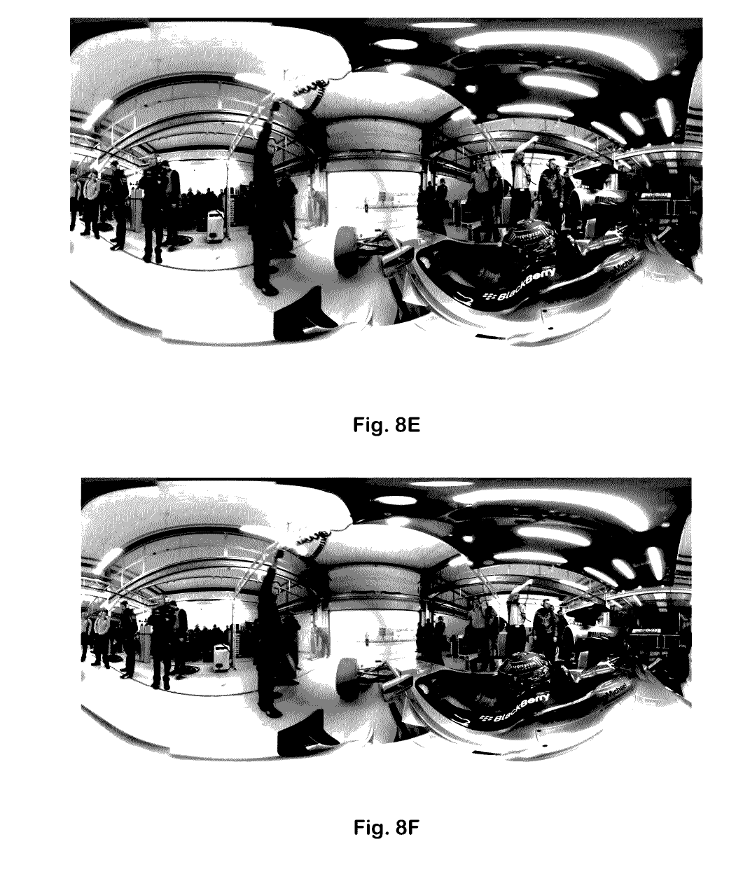

After parsing all the viewing data for a particular video, we are left with an array for each second that contains the different weights (number of times each section was viewed). The heatmap generating software accepts these arrays and turns them into easy to understand visualizations. We can then move through each second of the video to gain an understanding of how people experience it as a whole. As an example there is shown in FIGS. 8A-F a heatmap generated from ten views over the first six seconds of a video.

In yet a further embodiment, the heatmap can be used to describe where users are looking in the video, on an individual basis, in aggregate, or via segmentation. As a consequence, this offers video content creators analytics such as “x % were looking this way at this point in the video or what % of people saw the big explosion at 1:43?”

While 360 video provides users with a rich viewing experience and more content to consume in a single piece of video, the original content creator loses control of where to direct a user's attention. This results in users often getting “lost” looking around a video and missing important parts of the video storytelling. In yet a further embodiment, aggregated heat map data can be used to direct a user's attention in the video based on popular and common viewing experiences of others.

In another embodiment, the massive amounts of viewing data that is generated is used to detect “hotspots” in videos, or in other words, identifying points of interest. To do this, one uses the same method of data normalization, translating radians to coordinates on a 2D plane as described herein for cluster analysis. To identify hotspots, the present invention uses a combination of k-means and mean-shift clustering on the datasets for every second or interval of the video. As is known to those skilled in the art k-means and mean-shift are machine learning algorithms that take large amounts of point data and identify clusters, which in the present invention these are called the hotspots on the video.

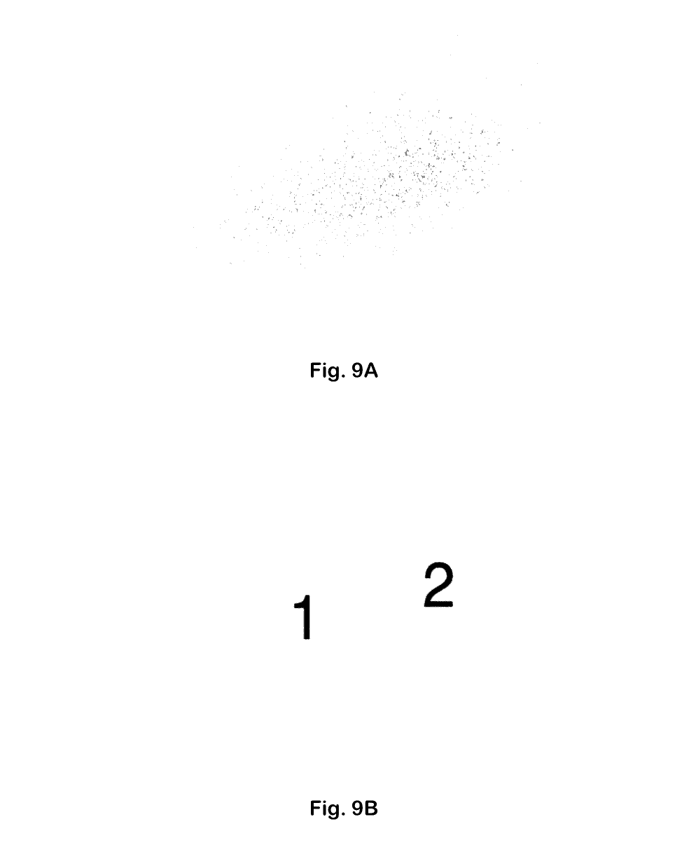

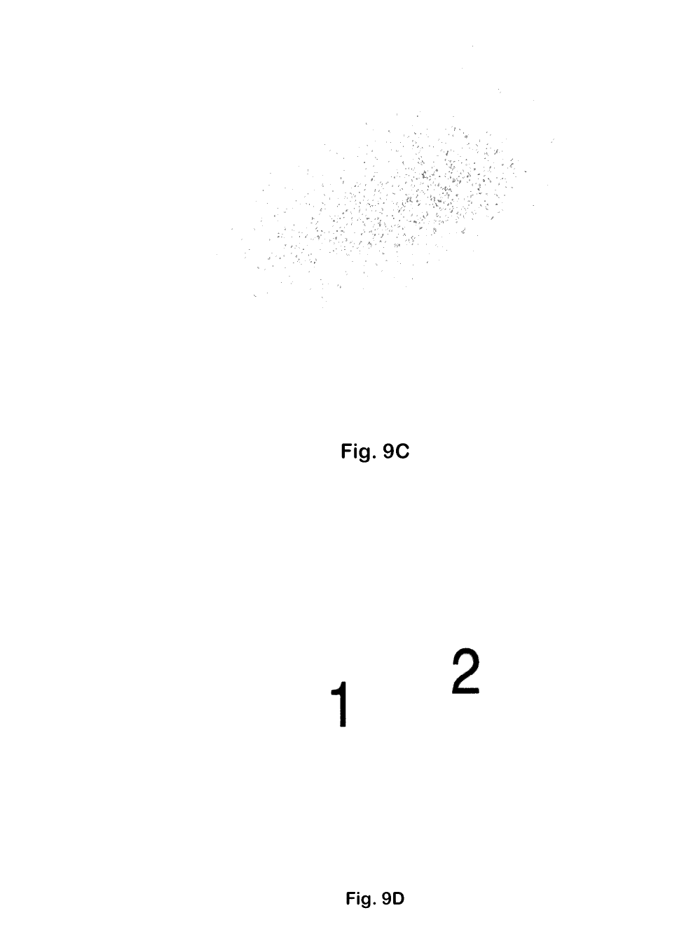

Referring now to FIG. 9A, there is shown an example of all the raw orientation data plotted for one second in one video. Each point represents the center of the screen of where the person was looking in the sphere. If people tended to look at certain areas of the video at a particular time, the cluster analysis would identify these areas. Cluster analysis of the above dataset resulted in two hotspots as shown in FIG. 9B. After identifying clusters in the videos, there are numerous applications that one can do with this data.

With the ability to find hotspots in videos through cluster analysis, one can offer a feature that allows a user to watch a 360 video without having to move the camera around to see the interesting parts of the video. Instead, the camera will move automatically for the user, centering on hotspots as they occur.

Let's say for example there is a 30 second video, and after cluster analysis, hotspots are identified at seconds 3, 10, and 22. If the user choses to watch the auto-generated viewing experience for this video, when the video plays, the camera would simply shift gracefully between the hotspots at seconds 3, 10 and 22. This provides a way for people to enjoy 360 video/VR without physically moving the camera (which many people do not like to do).

According to another embodiment, based on the data one has from the cluster analysis, the video encoding can be optimized based on where viewers are looking. If the majority of viewers (greater than 50%) view a small but similar portion of a full 360-degree video, then one could or should optimize the encoding so that the highest bitrate is optimized for the hotspots in the viewing experience. If the majority of viewers aren't watching certain parts of the video, then one could re-encode the video after a large enough aggregate of viewing data has been captured to focus the highest video image quality in the area that people are viewing the most. Video encoding has to spread varying amounts of data over individual frames for each second of video to maintain a certain level of quality.

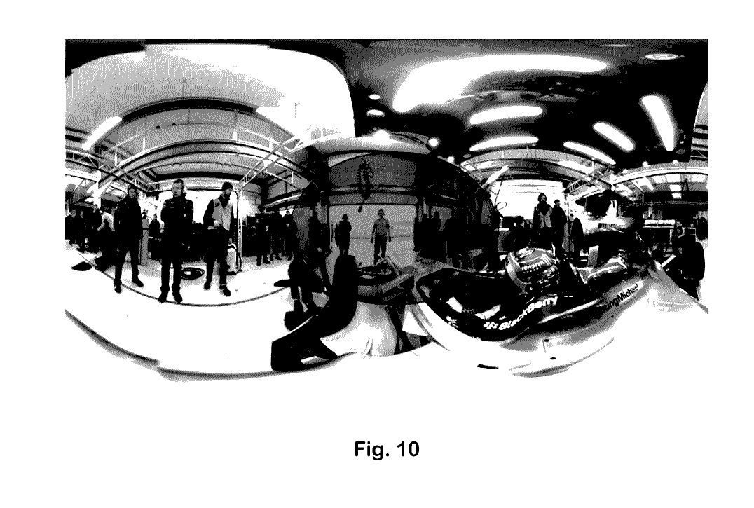

For example: 50 Mbps (Datarate) means 50 Megabits (50000000 bytes) of data is dedicated to rendering the video frames each second. Instead of spreading that data over an entire video frame, the bulk of the Datarate should be focused on where viewers are watching the most. The red dot or shaded dot/area in FIG. 10 would designate an aggregate of views, where the viewers are looking entirely at one spot over the course of one second. If the viewers all watched the center of the shown frame of FIG. 10 over the course of one second, the majority of the 50 Mbps Datarate would be focused specifically on the center of the frame. For example, of the 50 Mbps, 40 Mbps would be used to render the highest quality within the dot/shaded area, and 10 Mbps would be used to render the rest of the frame outside the dot. 40 Mbps+10 Mbps=50 Mbps. This would result in a much higher quality picture in the places where viewers are focusing their attention, and a lower quality in regions of the picture that aren't be viewed much, if at all.

In yet another aspect there is featured a “Spin” which is a summary of a viewing experience inside a 360 video. It is a recorded path an individual user took while watching a spherical video and includes all interactions with the video player, along with a summary of the orientations used while watching the video. Such a Spin stores someone's viewing experience efficiently (i.e., not using much space relative to the amount of data generated), and in such a way that experiences can be deconstructed and analyzed. In this way, one is able to record a “Spin” of a 360 video and then share it with other people so they can replay the experience.

Such a Spin also can be used in connection with 360 video viewing analytics. It allows one to show a heat map that describes where users are looking in the video, in aggregate or via segmentation. In use, the heat map shows that the vast majority of people never look behind the initial starting point of the video. It also allows content creators analytics such as “x % were looking this way at this point in the video” or “What % of people saw the big explosion at 1:43?”

In an embodiment, such Spins can be used to generate a lean back experience. More particularly, one is able to take all Spins for a specific piece of content and use machine learning to construct a lean-back experience. In addition, one also has the ability to add input weights on lean-back experiences for the purpose of “training” the machine learning algorithm.

The following provides a brief description of the underlying technology of this aspect of the present invention. In such an environment, a video player sits on top of a 360 video rendering engine. The video player is configured and arranged so as to store camera orientation data as quaternions that are mirrored as polar coordinates. The quaternions provide internal usage for controls, smooth movements, etc. and the polar coordinates are useful for spins/analytics/tracking.

According to another embodiment, the module that captures a viewing experience (all player interactions, viewing orientations, etc.) normalizes orientation data using polar coordinates so that experiences can be quantized and then analyzed and provides for viewing a 360 video that generates a lot of data (one quaternion per frame) whereas the present invention approximates a view by recording polar coordinates every second (as opposed to every frame). The data pipeline behind this embodiment sends large amounts of data to this single point and the data is then organized into logs that are stored. The unstructured log files are ingested by a data warehouse (Hadoop, Spark, etc.) for large-scale analysis (generate view reports, lean-back experiences, etc.).

Although a preferred embodiment(s) of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A method for rendering a 360 degree video comprising the steps of tracking the position of the viewer as the viewer watches the video and is looking around at the spherical content;
wherein said tracking further includes keeping track of two angles—radians—relative to the origin of the sphere;
recording the viewer's position periodically; and
at the end of a video, logging the tracking data.

2. The method of claim 1, further comprising the step(s) of:
determining a viewing route through the video taken by a prior viewer(s) using the tracking data; and
using the determined viewing route by a subsequent viewer so that the subsequent viewer can watch the video according to the determined viewing route.

3. The method of claim 2, wherein:
there is tracking data for a plurality of prior viewers; and
the viewing route is determined using the tracking data for the plurality of prior viewers

4. A method for generating a 3D heat map that shows an aggregate visualization of where everyone viewing the video has looked; said method comprising the steps of
tracking the position of the viewer as the viewer watches the video and is looking around at the spherical content;
wherein said tracking further includes keeping track of two angles—radians—relative to the origin of the sphere;
recording the viewer's position periodically;
at the end of a video, logging the tracking data;
parsing the logged tracking data; and
transforming the two radian values for each recorded view and generating a 2d array representative of the two radian values.

5. A system for rendering a 360 degree video comprising;
a computing device and
a software program for execution on the computing device, the software program including instructions, criteria and code segments for executing a method including the steps of:
tracking the position of the viewer as the viewer watches the video and is looking around at the spherical content;
wherein said tracking further includes keeping track of two angles—radians—relative to the origin of the sphere;
recording the viewer's position periodically; and
at the end of a video, logging the tracking data.

6. The system of claim 5, further the method embodied in the software program comprises the step(s) of:
determining a viewing route through the video taken by a prior viewer(s) using the tracking data; and
using the determined viewing route by a subsequent viewer so that the subsequent viewer can watch the video according to the determined viewing route.

7. The system of claim 6, wherein:
there is tracking data for a plurality of prior viewers; and
the viewing route is determined using the tracking data for the plurality of prior viewers
